(19) United States
(12) Patent Application Publication
(10) Pub. No.: US 2001/0008037 A1
(43) Pub. Date: Jul. 19, 2001

(54) Closure device for movable furniture parts

(76) Inventor: Klaus Brustle, Hochst (AT)

Correspondence Address: WENDEROTH, LIND & PONACK, L.L.P., Suite 800, 2033 K Street, N.W., Washington, DC, 20006, US

(21) Appl. No.: 09/758,216

(22) Filed: Jan. 12, 2001

(30) Foreign Application Priority Data
Jan. 14, 2000 (AT) A 50/2000

(51) Int. Cl. E05F 1/00

(52) U.S. Cl. 16/71

(57) ABSTRACT

A closure device (4) for movable furniture parts is combined with a closure damping mechanism, which is formed by a fluidic damper. The fluidic damper is either a rotation damper (20) or a linear damper. The closure device, together with the closure damping mechanism, is constructed highly compactly.

The invention relates to a closure device for movable furniture parts with a linearly displaceable slide acted upon by springs, which can be detachably coupled via a catch with the movable furniture part, and with a rotation damper, which comprises a pinion drive which meshes with a toothed rack section.

The invention further relates to a closure device for movable furniture parts with a linearly displaceable slide acted upon by springs, which can be detachably coupled via a catch with the movable furniture part, wherein a hydraulic damping mechanism is provided.

Such a closure device, which is applied in the case of drawers, is known, for example, from EP 0 391 221 B1. Therein the drawer, freely displaceable over a major portion of its pull-out range, is engaged in its rearward pull-in region by a catch of the pull-in device and reliably pulled into the rearward end position, i.e. it is closed.

According to GB 22 45 158 A the pull closure and pull-in device is provided with a rotation damper, which is said to prevent the impact loading during the closing of the drawer.

It is the task of the invention to improve such a closure and pull-in device to the extent that a gentle closing process and an extended service life of the closure and pull-in device is attained free of closing noise.

The task according to the invention is solved thereby that the toothed rack section is developed on the displaceable slide and the rotation damper is disposed stationarily.

A further embodiment example of the invention provides that the hydraulic damping mechanism comprises a piston linearly displaceable in a cylinder, wherein the cylinder or the piston is fixedly connected with the sliding carrier.

Thereby that the rotation damper is disposed stationarily, it is stressed less when the movable furniture part, for example a drawer, is displaced forward. The linear damper part (piston or cylinder), developed directly on the slider, is also distinguished through low wear and tear. In addition, through the compact construction in both cases is attained the quiet traversal of the closure or pull-in device.

The closure device according to the invention can be applied as a pull-in device for drawers as well as also as a closure device for door leaves. In the latter case the door also freely swivellable over the major portion of its opening path and only when it approximates the closure position in the closing process is it engaged by the closure device and is closed securely.

In the following, different embodiments of the invention will be described in detail below with reference to the enclosed drawings, wherein

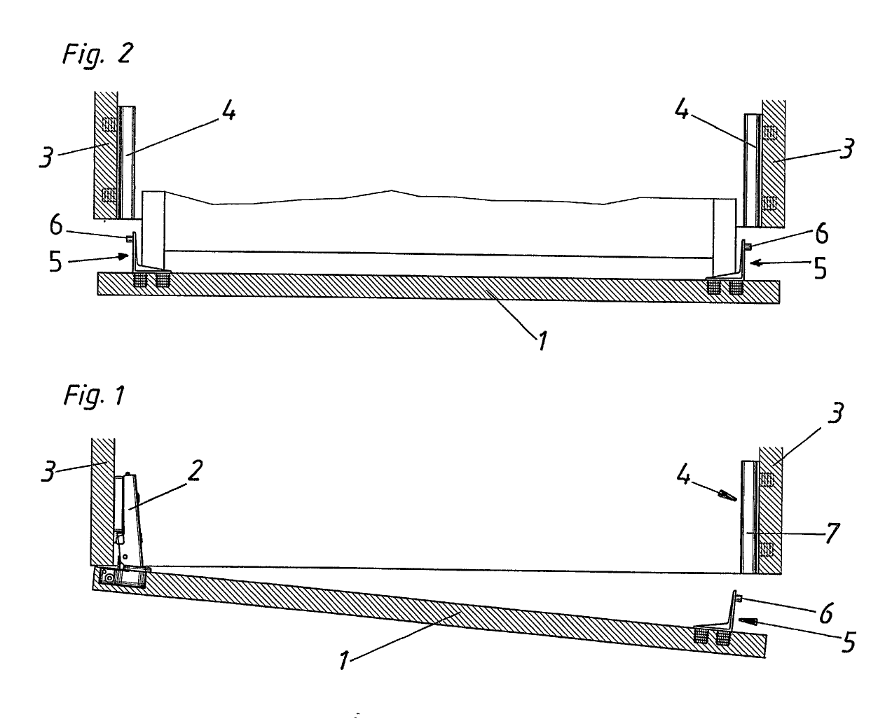

FIG. 1 is a schematic section through the front region of a furniture body and a door, wherein on one body side wall a closure mechanism according to the invention is mounted,

FIG. 2 is a schematic section through the front region of a furniture body and a drawer, wherein on both body side walls a closure device according to the invention is mounted,

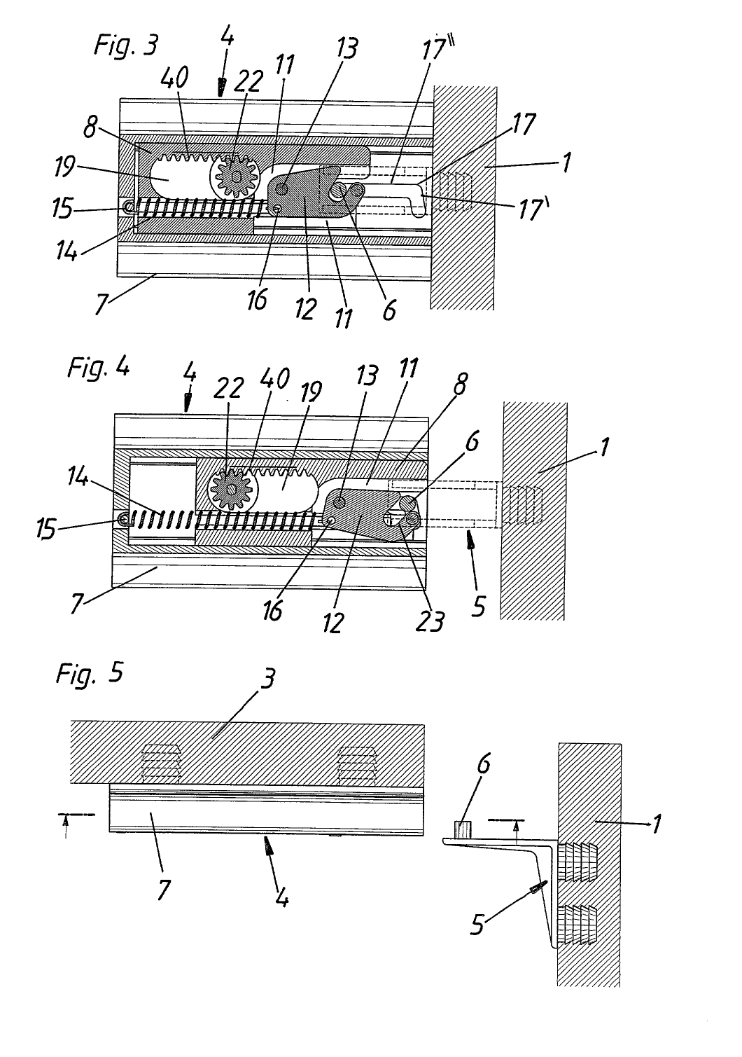

FIGS. 3 and 4 each are a section through a closure mechanism according to the invention,

FIG. 5 is a section through a body side wall and a door leaf as well as a top view onto the closure mechanism according to the invention,

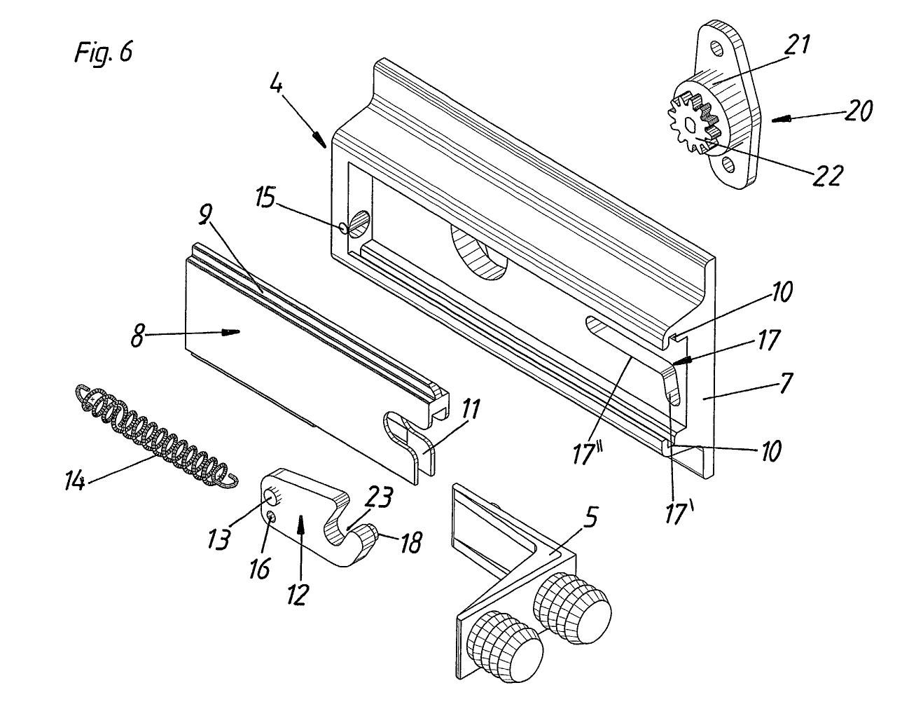

FIG. 6 is a diagram of the closure mechanism according to the invention according to FIGS. 1 to 5, spread apart,

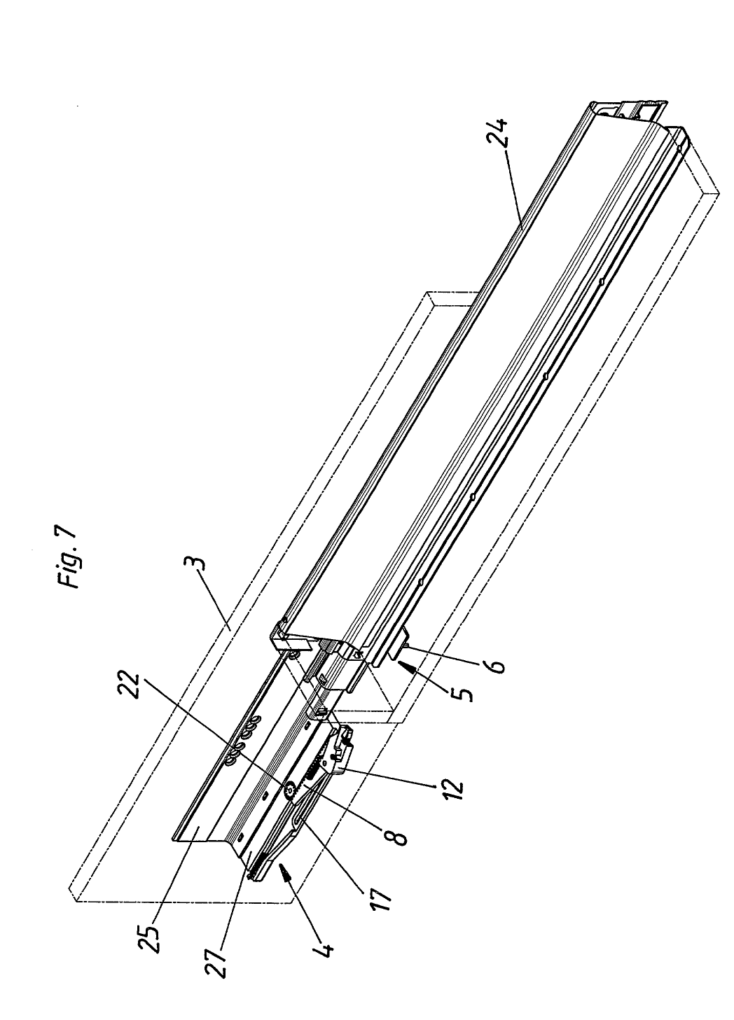

FIG. 7 is a diagram of a pull-out guidance assembly, which is equipped with a closure device according to the invention,

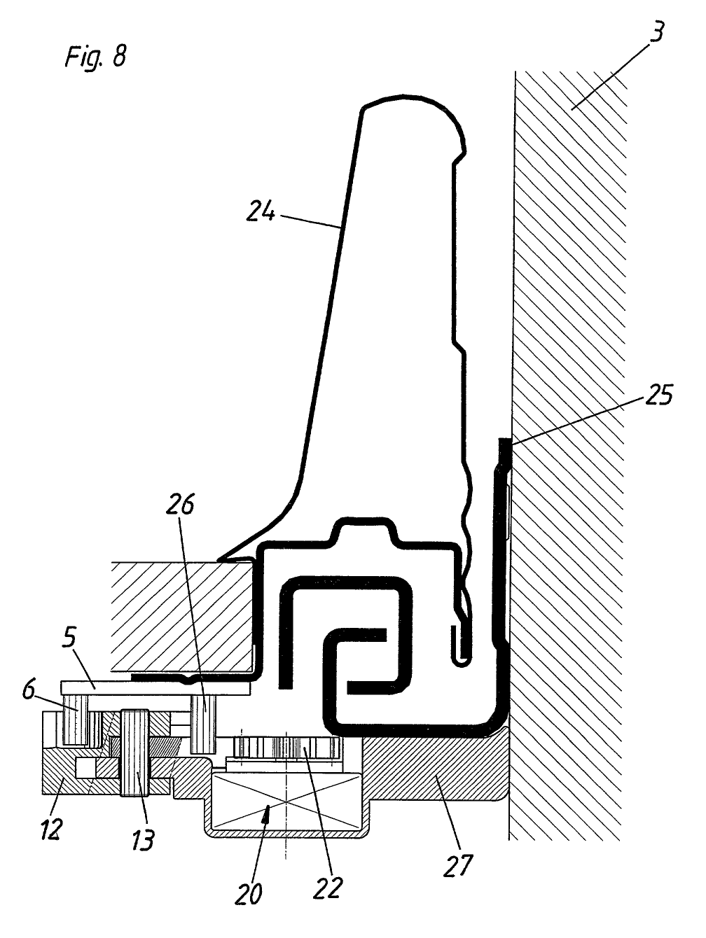

FIG. 8 is a vertical section through such a pull-out guidance assembly,

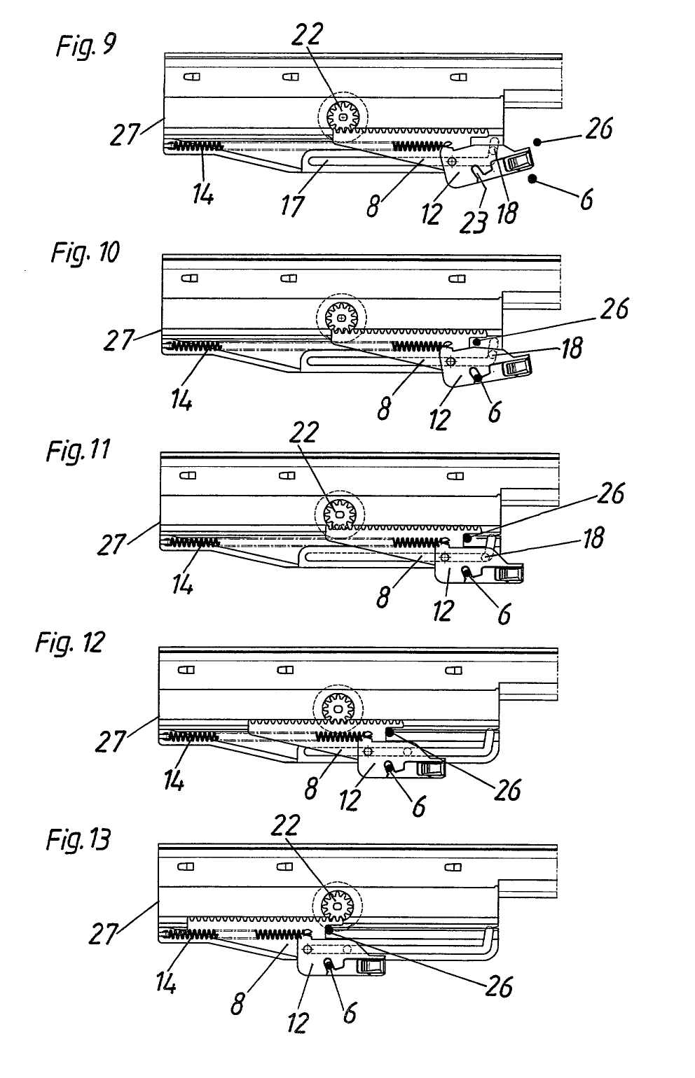

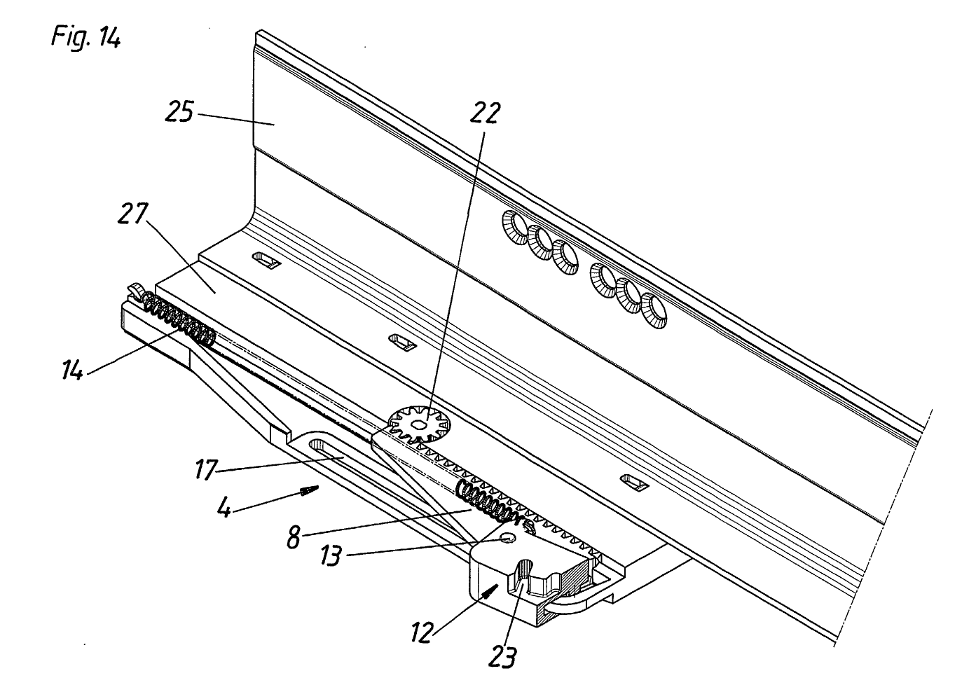

FIGS. 9 to 13 each are a top view onto a closure device according to the invention, wherein different stages of the closure movement are shown,

FIG. 14 is a diagram of a closure device according to the invention according FIGS. 7 to 13,

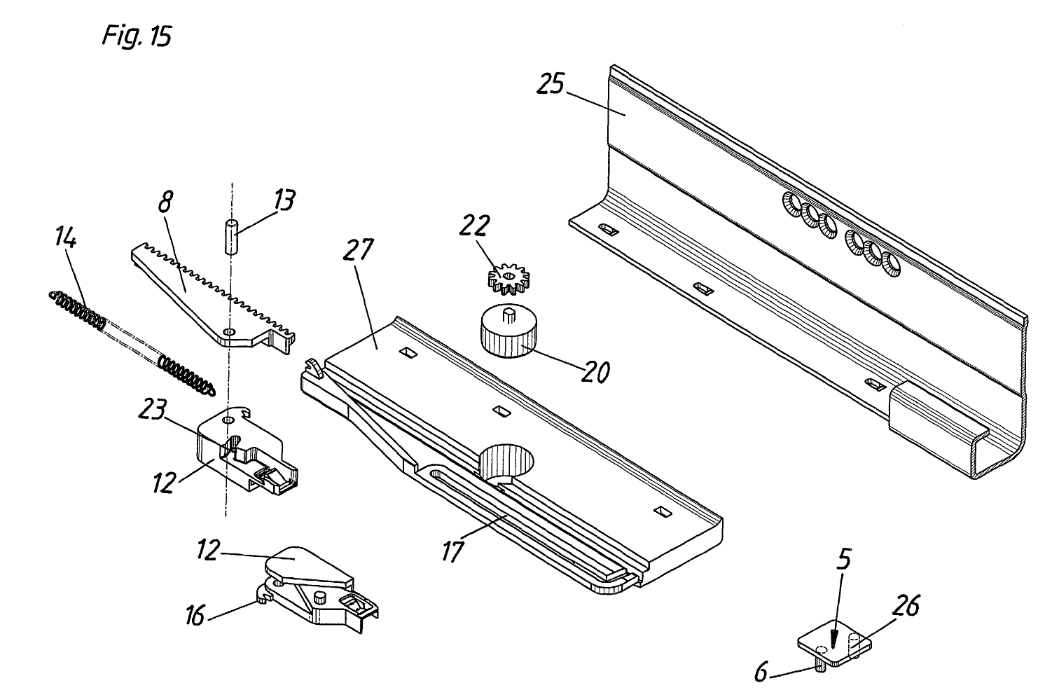

FIG. 15 is a spread-apart diagram of the closure device according to the invention,

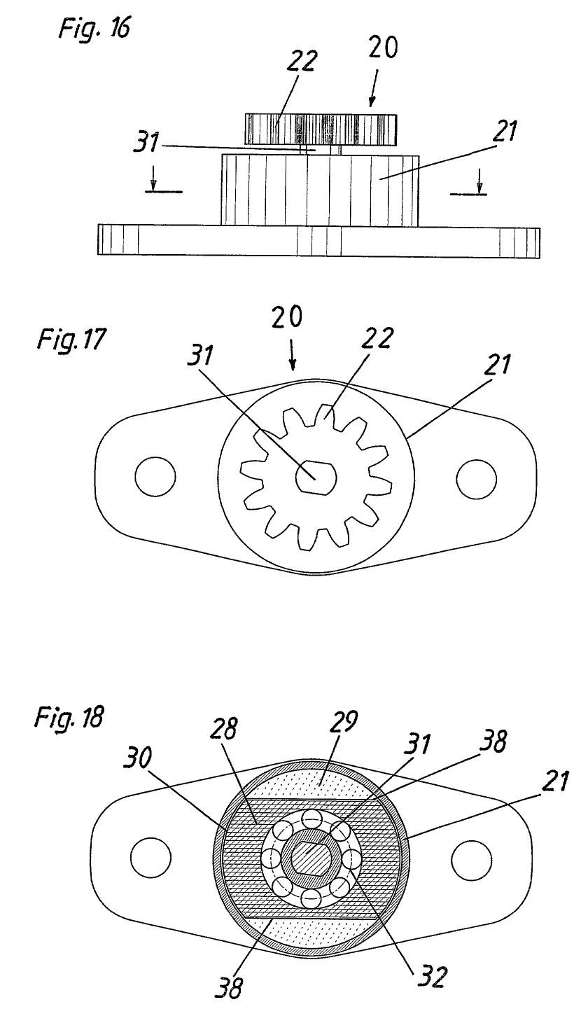

FIG. 16 is a side view of a rotation damper,

FIG. 17 is a top view onto a rotation damper,

FIG. 18 is a section according to the section line in FIG. 16,

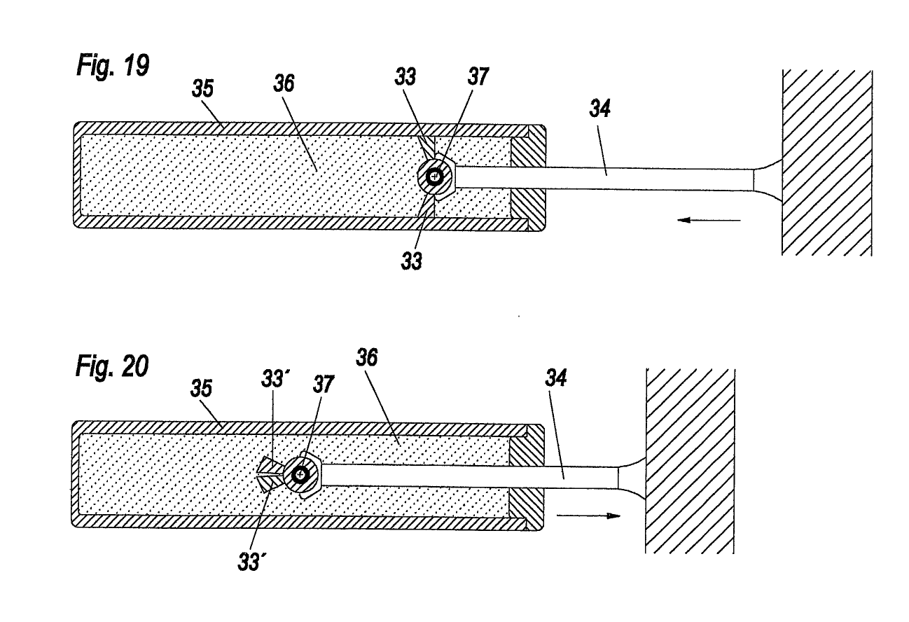

FIG. 19 is a schematic section through a linear damper in the functional position,

FIG. 20 is a schematic section through a linear damper in the return phase,

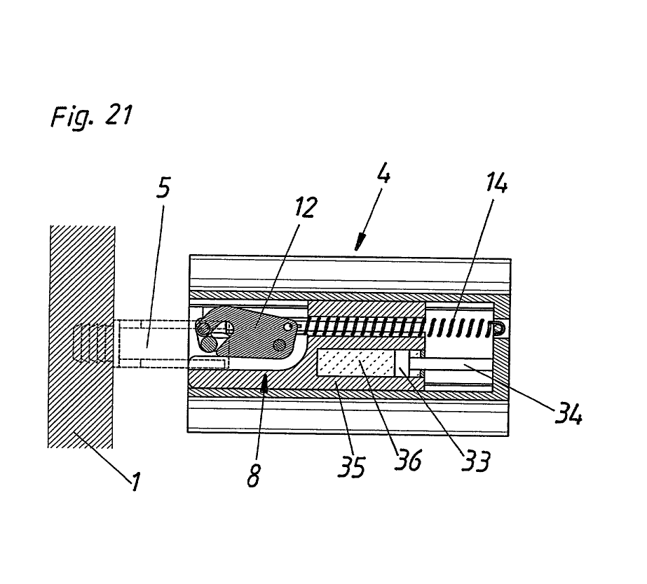

FIG. 21 is a section through a closure device according to the invention with an integrated linear damper, and

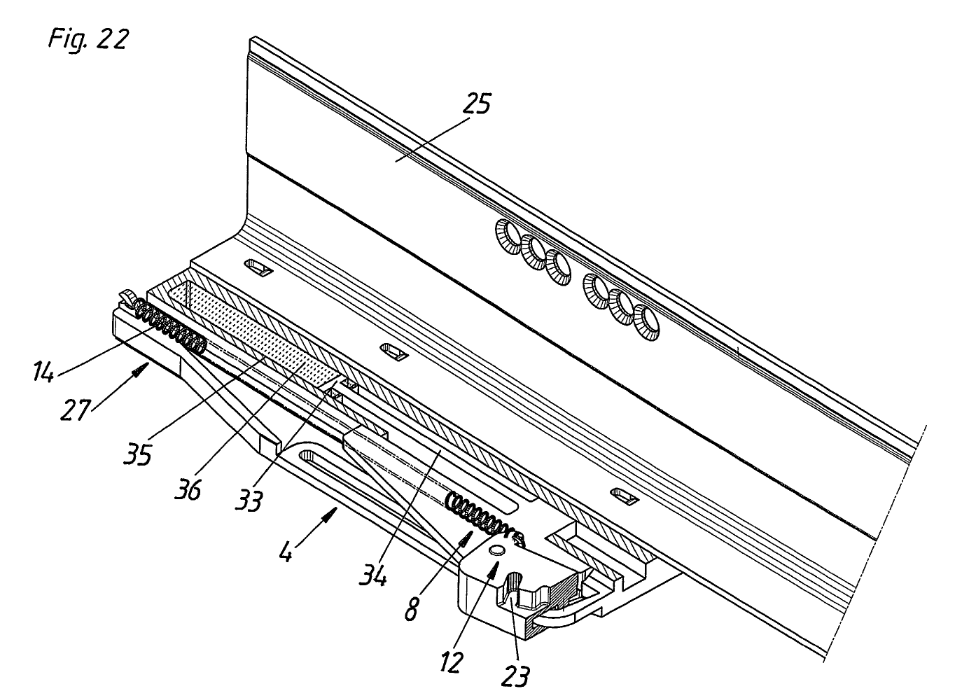

FIG. 22 is a diagram partially sectioned of a further embodiment of a closure device according to the invention with an integrated linear damper.

In FIG. 1 a door is articulated by means of a hinge joint 2 in conventional manner on a body side wall 3. On the side wall 3 opposing the hinge joints 2 is disposed the closure device 4 according to the invention and on the free end of the door 1 the arresting part 5 with an arresting pin 6. The arresting part 5 as well as the housing 7 of the closure device 4 are fastened in the conventional manner by means of dowels on the body side walls 3 or on the door 1.

In the embodiment according to FIG. 2 a drawer is set into a furniture body.

On the two side walls of the furniture body is fastened a closure device 4.

On the front panel 1′ of the drawer two arresting parts 5 with pins 6 are mounted. If the drawer is being closed, the arresting parts 5 are engaged on both sides of the drawer by the closure device 4 and brought into the most rearward closure position.

As is evident in FIG. 4, in the embodiment according to FIGS. 3 to 6 in the housing 7 of the closure device a slide 8 is supported so as to be linearly displaceable. The slide 8 comprises guidance flanges 9, which are guided in corresponding guidance grooves 10 of housing 7 (FIG. 6).

In the slide 8, which is implemented with a chamber-like recess 11 at the front, a catch 12 is supported. The catch 12 is structured as a toggle part and rests by means of an axle 13 in the slide 8.

A spring 14 is provided which is anchored on the one hand, on a bearing site 15 on housing 7 and, on the other hand, is secured in position on a bearing site 16 directly on catch 12. The catch 12 is thus acted upon directly by the spring 14. The spring 14 is a tension spring.

In the housing 7 a guidance course 17 is provided which comprises an angled end 17 and which can be structured as a slot or a groove. Into the guidance course 17 projects a pin 18 of the catch 12.

Furthermore a rotation damper 20 is provided, which can be developed directly in the housing 7 or, as in the embodiment shown, can comprise a separate housing 21 which projects into the housing 7.

The slide 8 is provided with a recess 19 within which the pinion gear 22 of the rotation damper 20 is disposed. The pinion gear 22 meshes therein with a toothed rack section 40 developed on the slide 8.

In the position of the door 1 or the front panel 1 of the drawer shown in FIG. 5, the closure device 4 is out of function.

In the position shown in FIG. 4, in which the door 1 or the drawer is almost closed, the arresting pin 6 is brought into engagement with catch 12, i.e. it travels into the notch 23 of catch 12. Through the closing movement of the door 1 or the front panel 1 the catch 12 is pressed in the rearward direction and through the cooperation of the guidance pin 18 with the guidance course 17 catch 12 is rotated about the axle 13.

As soon as the guidance pin 18 is in the straight region 17 of the guidance course 17, the catch 12 and with it the sliding carrier 8 is pulled toward the back by spring 14.

Therein the toothed rack section 40 rotates the pinion gear 22 and thus the rotation damper 20. In the case of too high a closing speed of the door 1 or of the front panel 1 the rotation damper 20 strongly brakes the door leaf 1 or the drawer. At low closing speed of the door 1 or the drawer the spring 14 is strong enough to rotate the rotary piston 28 of the rotation damper 20 slowly and close the door 1 or the drawer.

Consequently a gentle closing process is attained free of closing noise.

In the embodiment according to FIGS. 7 to 14 the closure device 4 is supported on a support rail 25 of a pull-out guide assembly. The arresting part 5 is fastened on a drawer side wall 24 and comprises an arresting pin 6 projecting downwardly and a bolt 26 which forms a stop.

Instead of a housing the closure device 4 comprises a bearing plate 27 which is anchored on a horizontal flange of the support rail 25.

On the bearing plate 27, is disposed the linearly displaceable slide 8, on which the catch 12 is supported so as to be able to toggle The catch 12 comprises an axle 13 by means of which it is supported on slide 8, and a guidance pin 18 which projects into a guidance course 17, which is developed as a slot or as a groove.

As in the previously described embodiment example, on the slide 8 a toothed rack section 40 is developed, which meshes with a pinion gear 22 of a rotation damper.

A spring 14 is anchored on a bearing site 15 on the holding plate 17 and engages the catch 12 directly.

In the position shown in FIG. 9 the closure device 4 is out of function. When the drawer is being closed, the drawer side wall 24 is moved toward the rear of the piece of furniture, the catch pin 6 snaps into the notch 23 of the catch 12 and starts to rotate the catch 12 into the closing position. Initially the stop 26 has no contact with the slide 8 of the closure device 4. A pull-in device 4 with a stop 26 is applied in particular in the case of heavy drawers. In the case of light drawers and doors, a closure device 4 without stop 26 as described in FIGS. 2 to 5 is sufficient.

In the position shown in FIG. 1 the catch 12 is rotated into the closing position and the stop 26 abuts the slide 8. In this situation the damping function is in operation. At high closing speed of the drawer the rotation damper 20 strongly brakes the drawer. At low closing speed the spring 14 is strong enough to rotate via the slide 8 the pinion gear 22 and thus the rotary piston 28 of the rotation damper 20 and to close the drawer. Therein a gentle closing process without closing noise is always attained.

FIGS. 16 to 18 show an embodiment of the rotation damper 20. Therein in a housing 21 a rotary piston 28 with flat sides 38 is provided. In the housing 21 is disposed a damping fluid 29, preferably an oil.

Between the housing wall 21 and the rotary piston 28 is provided a brake clearance 30.

The transmission of the torsional force from axle 31 of the pinion gear 22 onto the rotary piston 28 takes place by means of a free-running device 32 known per se, whereby the opening of the drawer is facilitated.

Instead of a rotation damper 20 the closure device 4 according to the invention can also be provided with a linearly displaceable piston 33, as is shown in FIGS. 19 to 22. In the embodiment according to FIG. 22 the slide 8 is connected with a piston rod 34, which bears the piston 33. Piston 33 is linearly displaceable in a cylinder 35, in which is disposed a damping fluid 36. As the damping fluid used can be air, gases or a damping liquid, for example oil. The piston 33, as shown in FIGS. 19 and 20, can be implemented as a foldable piston. In the functional position shown in FIG. 19 the piston halves 33″, which are rotatable about an axis 37, are hinged open and close to the wall of the cylinder 35. The resistance of the damping fluid 29 against the piston movement is thus very high.

In the piston 33 is drawn back, the piston halves 33′ are folded together, as shown in FIG. 20, wherewith the resistance of the damping fluid 29 against the piston movement is very low and therefore the piston 33 can readily be pulled into the starting position by the piston rod 34.

In the embodiment shown in FIG. 21 the cylinder 35 is developed directly in the slide 8 and the piston 33 is disposed stationary with its piston rod 34 on the housing 7.

1. Closure device for movable furniture parts with a linearly displaceable slide acted upon by a spring, which can be detachably coupled via a catch with the movable furniture parts, and with a rotation damper comprising a pinion gear, which meshes with a toothed rack section, characterised in that the toothed rack section is developed on the displaceable slide (8) and the rotation damper (20) is disposed stationarily.

2. Closure device for movable furniture parts with a linearly displaceable slide acted upon by a spring, which can be detachably coupled via a catch with the movable furniture part, wherein a hydraulic damping mechanism is provided, characterised in that the hydraulic damping mechanism comprises two parts which are linearly displaceable in respect to each other, namely a piston (33) and a cylinder (36), wherein one of the parts is fixedly connected with the slide (8).

3. Closure device as claimed in claim 2, characterised in that the piston (33) is fixedly connected with the slide (8).

4. Closure device as claimed in claim 2, characterised in that the cylinder (36) is fixedly connected with the slide (8).

5. Closure device as claimed in claim 1, characterised in that the slide (8) rests in a bearing plate (27).

6. Closure device as claimed in claim 5, characterised in that the bearing plate (27) is mounted on a body-side support rail (25) of a pull-out guide assembly.

7. Closure device as claimed in claim 2, characterised in that the cylinder (36) is developed in the slide (8).

8. Closure device as claimed in claim 2, characterised in that a catch (12) for the movable furniture part is supported on the slide (8).

9. Closure device as claimed in claim 8, characterised in that the catch (12) is developed as a toggle part.

10. Closure device as claimed in claim 9, characterised in that the catch (12) is supported rotatably by means of an axle (13) on the slide (8), and comprises a guidance pin (18) which projects into a guidance course, which comprises an angled end (17′).

11. Closure device as claimed in claim 10, characterised in that the guidance course is formed by a guidance groove (17).

12. Closure device as claimed in claim 1, characterised in that the sliding carrier (8) comprises a recess (19) into which projects the pinion gear (22) of the rotation damper (20).

13. Closure device as claimed in claim 8, characterised in that the catch (12) is received in a chamber-like recess (11) of the slide (8).

14. Closure device as claimed in claim 8, characterised in that on the part carried along by the catch (12) is provided a stop (26) which abuts on the slide (8).

15. Closure device as claimed in claim 14, characterised in that on the part carried along by the catch (12) an arresting part (5) with two bolts is provided, wherein one of the bolts forms an arresting pin (6) which is engaged by the catch (12) and the other bolt forms the stop (26).

16. Closure device as claimed in claim 1, characterised in that the rotation damper (20) comprises a rotary piston (28) which is immersed in a damping fluid (29).

17. Closure device as claimed in claim 2, characterised in that in the cylinder (36) is disposed a fluid.

18. Closure device as claimed in claim 17, characterised in that as the fluid used is air or a gas.

19. Closure device as claimed in claim 14, characterised in that as the fluid used is a liquid, preferably an oil.

20. Closure device as claimed in claim 2, characterised in that the piston (33) comprises two foldable piston halves (33′).
